(19) United States
(12) Patent Application Publication
(10) Pub. No.: US 2011/0200378 A1
(43) Pub. Date: Aug. 18, 2011

(54) CONTINUOUS PAPER TRANSPORTATION CONTROL METHOD AND PRINTER

(75) Inventor: Ryuji Moriyama, Matsumoto-shi (JP)

(73) Assignee: SEIKO EPSON CORPORATION, Shinjuku-ku (JP)

(21) Appl. No.: 13/030,077

(22) Filed: Feb. 17, 2011

(30) Foreign Application Priority Data
Feb. 18, 2010 (JP) 2010-033242
Aug. 30, 2010 (JP) 2010-191839

(51) Int. Cl. B41J 11/44; B65H 20/02

(52) U.S. Cl. 400/583; 226/4

(57) ABSTRACT

A printer (1) has a paper feed roller (11) and a tractor (6) for conveying continuous paper (2) passed a printing position. During printing, the paper feed roller (11) is intermittently rotationally driven at a speed enabling conveying the continuous paper (2) a second feed distance per unit time, and the tractor (6) is held in a state enabling it to be rotated pulled by the continuous paper by means of the paper feed roller (11) while being intermittently rotationally driven synchronously to the paper feed roller (11) at a speed enabling conveying the continuous paper (2) a first feed distance that is less than a second feed distance per unit time (steps ST1, ST2). Each time the continuous paper (2) is conveyed one page length, the paper feed roller (11) is additionally rotated to eliminate a feed distance deficiency due to slipping (steps ST31 to ST33). The printer can therefore convey continuous paper with good precision without applying a great load, and can prevent a drop in print quality.

### BACKGROUND

1. Technical Field

The present invention relates to a method of controlling transportation of continuous paper with good precision passed the printing position of a printer using a tractor and paper feed rollers, and to a printer that conveys continuous paper using this transportation control method.

2. Related Art

Printers that print on continuous paper in which engagement holes for conveying the paper are formed, and convey the continuous paper using a tractor and paper feed rollers, are known from the literature.

A common tractor is described in Japanese Unexamined Patent Appl. Pub. JP-A-2006-232470. This tractor has a tractor belt formed around the outside of tractor pins (engagement parts) that can be inserted to sprocket holes (engagement holes) formed along the length of continuous paper. The tractor belt is mounted between a drive sprocket and a follower sprocket. The continuous paper is set in the tractor so that the tractor pins are inserted in the sprocket holes. Once the continuous paper is set, the continuous paper can be conveyed by the tractor turning the tractor belt by causing the drive sprocket to rotate by means of drive power from a drive source, thus causing the tractor pins to sequentially engage the sprocket holes in the continuous paper and convey the paper.

Japanese Unexamined Patent Appl. Pub. JP-A-2009-119574 and Japanese Unexamined Patent Appl. Pub. JP-A-2002-348012 describe printers that have a tractor and paper feed roller to convey continuous paper. JP-A-2009-119574 teaches a printer in which the printing position of the printhead is between the paper feed roller and tractor. While printing, the continuous paper is intermittently advanced a specific distance by synchronously driving the paper feed roller and tractor.

JP-A-2002-348012 teaches a printer in which during printing the tractor switches from a drive mode to a follower mode, the continuous paper is conveyed only by the paper feed roller, and the tractor rotates following the continuous paper conveyed by the paper feed roller.

The diameter of the tractor pins is smaller than the inside diameter of the sprocket holes so that the tractor pins of the tractor will reliably enter the sprocket holes in the continuous paper. As a result, the position of the tractor pins in the sprocket holes can shift forward and back in the transportation direction when the tractor pins convey the continuous paper. When the tractor pins shift in the sprocket holes, the transportation distance of the continuous paper also varies. A drop in print quality can therefore be prevented if the continuous paper is conveyed during printing using only the paper feed roller because there is no variation in the feed distance of the continuous paper.

The continuous paper is conveyed to the printing position while threaded around the tractor and paper feed roller. As a result, when continuous paper transportation starts using only the paper feed roller when media transportation begins for printing, a strong transportation load (tension) is temporarily applied by the inertia of the tractor in the standby state. Because the tractor has drive and follower sprockets, and a tractor belt that is mounted on the sprockets, the inertial force is high relative to the paper feed roller, and the tension applied to the continuous paper when transportation begins is relatively high.

When the continuous paper has perforations extending across the paper width at regular intervals down the paper length, a heavy load (tension) momentarily applied to the paper can cause the continuous paper to tear at a perforation. More particularly, because the continuous paper is stiff when the printer operates in a low temperature environment, the paper can tear easily starting at a perforation. In addition, because the continuous paper is more pliable when the printer is operating in a high temperature environment, the paper can also tear easily starting at a perforation.

When continuous paper is intermittently conveyed passed the printing position to print one line at a time by means of a printhead, high tension is repeatedly applied to the continuous paper, and the continuous paper can therefore easily tear starting at a perforation, for example.

Yet further, if the feed load (tension) on the continuous paper varies greatly when the paper is conveyed intermittently, slipping occurs between the continuous paper and the paper feed roller, and the continuous paper cannot be conveyed with good precision at a constant rate passed the printing position. A drop in the paper feed precision of the continuous paper results in a drop in print quality and is therefore undesirable.

### SUMMARY

The present invention is directed to solving this problem by providing a continuous paper transportation control method that can be convey continuous paper by means of a paper feed roller and tractor with good precision without applying a heavy load to the continuous paper.

The invention also provides a printer that can convey continuous paper passed a printing position with good precision by means of the foregoing novel method of controlling conveying continuous paper.

A first aspect of the invention is a continuous paper transportation control method using a tractor that conveys the continuous paper while sequentially engaging engaging units with engagement holes formed in the continuous paper along the length of the continuous paper, and a paper feed roller that conveys the continuous paper received from the tractor through a paper transportation path passed a printing position, and includes the following steps that are executed at least when printing on the continuous paper: setting the tractor to a state enabling rotation following the continuous paper that is pulled in the direction of the paper feed roller by the paper feed roller; rotationally driving the tractor at a speed enabling conveying the continuous paper at a first feed distance per unit time and conveying the continuous paper; and rotationally driving the paper feed roller at a speed enabling conveying the continuous paper a second feed distance that is greater than the first feed distance per unit time.

At least when printing on continuous paper, the invention drives both the paper feed roller and the tractor to convey the continuous paper. Unlike when the tractor is stopped and completely switched to a following rotation mode, the tractor is also rotationally driven a specific feed distance. Because the feed load (tension) acting on the continuous paper when transportation starts, for example, can thus be greatly reduced, tearing the continuous paper can be prevented.

Furthermore, because slipping between the paper feed roller and the continuous paper can be suppressed because the feed loading acting on the continuous paper can be reduced, the continuous paper can be conveyed with no variation.

In addition, because the tractor is set to a state enabling a following rotation (enabling the tractor to rotate freely) in the direction in which the continuous paper is conveyed, and the continuous paper feed distance of the paper feed roller is greater than the continuous paper feed distance of the tractor, conveyance of the continuous paper is controlled by the paper feed roller. As a result, the continuous paper can be conveyed passed the printing position with good precision and no variation.

A continuous paper transportation control method according to another aspect of the invention also has another step of rotating the paper feed roller an additional specific amount when the feed distance of the continuous paper calculated based on the amount of rotation of the paper feed roller reaches a predetermined set feed distance.

By thus rotating the paper feed roller an appropriate additional amount for each set feed distance, the feed distance deficiency caused by slipping between the paper feed roller and the continuous paper can be eliminated.

In this case the feed distance deficiency of the continuous paper that occurs each feed distance amount can be calculated and obtained from the actual feed distance of the continuous paper and how far the tractor has rotated. More specifically, the actual feed distance of the continuous paper can be calculated from the rotational amount of the tractor or the movement of the engagement holes in the continuous paper. If the feed distance of the continuous paper calculated from the rotation of the paper feed roller reaches the set feed distance, the paper feed roller is rotated an additional amount so that the actual feed distance matches the set feed distance. As a result, the deficiency in the continuous paper feed distance can be corrected with good precision.

In this aspect of the invention, the set feed distance can be set to the feed distance that conveys the continuous paper only the length of a predefined print page. As a result, when printing a new page of the continuous paper starts, the printing start position on the continuous paper can be accurately positioned.

When the continuous paper is conveyed by intermittently rotationally driving the paper feed roller a preset set rotational amount in the length direction of the continuous paper, the continuous paper may be conveyed by intermittently rotationally driving the tractor synchronized to intermittently rotationally driving the paper feed roller. In this case the set feed distance can be set to the feed distance of the continuous paper when the paper feed roller is rotated the set amount of rotation. As a result, the paper feed precision of the continuous paper can be improved because the deficient portion of the continuous paper feed distance is corrected each time the continuous paper is intermittently conveyed.

Next, during media transportation other than when printing on the continuous paper, the control unit preferably rotationally drives the tractor synchronously to the paper feed roller at a speed that enables conveying the continuous paper the same feed distance as the paper feed roller.

More specifically, when conveying the continuous paper forward when not printing, there is no need to consider a drop in print quality due to variation in the continuous paper feed distance by the tractor. In this case the tractor is preferably rotationally driven synchronously to the paper feed roller at a speed enabling conveying the continuous paper the same feed distance as the paper feed roller. This can greatly reduce the tension on the continuous paper, and can reliably avoid tearing the continuous paper. In addition, if slack occurs in the continuous paper between the paper feed roller and the tractor when backfeeding the continuous paper, problems such as continuous paper jams and tearing the continuous paper as a result can easily occur. When the continuous paper is backfed, the tractor is therefore preferably rotationally driven synchronously to the paper feed roller at a speed enabling conveying the continuous paper the same feed distance as the paper feed roller.

A stepper motor is preferably used to rotationally drive the tractor. Rotational drive control, such as intermittent rotational drive control, is simplified by using a stepper motor.

Another aspect of the invention is a printer including a printhead; a transportation path for continuous paper that passes a printing position of the printhead; a tractor for conveying the continuous paper through the transportation path while sequentially engaging engaging units with engagement holes formed in the continuous paper along the length of the continuous paper; a paper feed roller disposed between the printing position and the tractor for conveying the continuous paper through the transportation path; and a control unit that controls a transportation operation to rotationally drive the paper feed roller and the tractor to convey the continuous paper, and a printing operation that prints on the continuous paper by means of the printhead. At least when printing on the continuous paper, the tractor is in a state enabling rotation following the continuous paper that is pulled in the direction of the paper feed roller by the paper feed roller; and when printing on the continuous paper, the control unit drives the tractor at a speed enabling conveying the continuous paper at a first feed distance per unit time, and drives the paper feed roller at a speed enabling conveying the continuous paper a second feed distance that is greater than the first feed distance per unit time.

At least when printing on continuous paper, the invention drives both the paper feed roller and the tractor to convey the continuous paper. Unlike when driving the tractor is stopped and the tractor is set to a following rotation mode, the tractor is also rotationally driven a specific feed distance. Because the feed load (tension) acting on the continuous paper when transportation starts, for example, can thus be greatly reduced, tearing the continuous paper can be prevented.

Furthermore, because slipping between the paper feed roller and the continuous paper can be suppressed because the feed loading acting on the continuous paper can be reduced, the continuous paper can be conveyed with no variation.

In addition, because the tractor is set to a state enabling a following rotation in the direction in which the continuous paper is conveyed, and the continuous paper feed distance of the paper feed roller is greater than the continuous paper feed distance of the tractor, conveyance of the continuous paper is controlled by the paper feed roller. As a result, the continuous paper can be conveyed passed the printing position with good precision and no variation. The printer according to this aspect of the invention can therefore suppress continuous paper waste, convey the continuous paper with good precision, and thereby suppress a drop in print quality.

In a printer according to another aspect of the invention the control unit rotates the paper feed roller an additional specific amount when the calculated feed distance of the continuous paper that is calculated based on the amount of rotation of the paper feed roller reaches a predetermined set feed distance.

A printer according to another aspect of the invention therefore preferably also has an encoder that detects an amount of rotation of the tractor, or a sensor that detects an amount of movement of the engagement holes in the continuous paper; the control unit including a feed distance evaluation unit that determines if the calculated feed distance reached the set feed distance, an actual feed distance calculation unit that calculates the actual feed distance of the continuous paper based on output from the encoder or output from the sensor, a difference calculation unit that calculates the difference between the actual feed distance and the set feed distance, and an amount of rotation correction unit that controls the amount of rotation of the paper feed roller in the direction eliminating the difference.

Further preferably, the set feed distance is a feed distance equal to a predetermined length of one printed page of the continuous paper.

In according to another aspect of the invention, when the control unit intermittently rotationally drives the paper feed roller a predetermined set amount of rotation in the length direction of the continuous paper, intermittently rotationally drives the tractor synchronously to intermittently rotationally driving the paper feed roller, and conveys the continuous paper, the set feed distance is the feed distance of the continuous paper when the paper feed roller is rotated the set amount of rotation.

In another aspect of the invention, during continuous paper transportation when not printing, the control unit rotationally drives the tractor at a speed enabling conveying the continuous paper the same feed distance as the feed distance of the paper feed roller while synchronously rotationally driving the paper feed roller.

So that the tractor can be pulled and rotated by the continuous paper (following rotation) simultaneously to rotationally driving the tractor a specific feed amount, a printer according to another aspect of the invention can be configured with a tractor drive motor that rotationally drives the tractor; a drive power transmission mechanism that transfers output rotation of the tractor drive motor to the tractor as rotational drive power for the tractor; and a clutch mechanism that connects the tractor to the drive power transmission mechanism so that the tractor can rotate following the continuous paper.

A printer according to another aspect of the invention also has a printer assembly including the printhead and the paper feed roller; and a tractor unit including the tractor, the tractor drive motor, the drive power transmission mechanism, and the clutch mechanism, the tractor unit being removably installed to the printer assembly.

In a printer according to another aspect of the invention, the tractor drive motor is preferably a stepper motor.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an external oblique view of a printer according to the invention.

FIG. 2 schematically describes the internal configuration of the printer shown in FIG. 1.

FIG. 3 is a schematic block diagram of the control system of the printer shown in FIG. 1.

FIG. 4 is a flow chart describing the continuous paper transportation and printing operation of the printer shown in FIG. 1.

### DESCRIPTION OF EMBODIMENTS

A preferred embodiment of a printer according to the invention is described below with reference to the accompanying figures.

### General Configuration

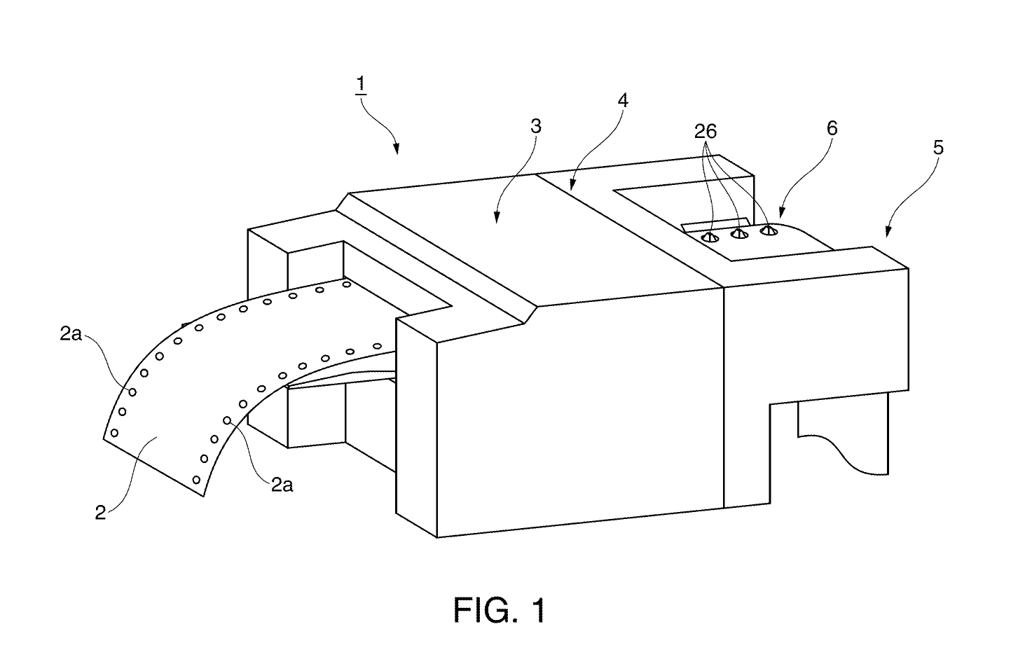

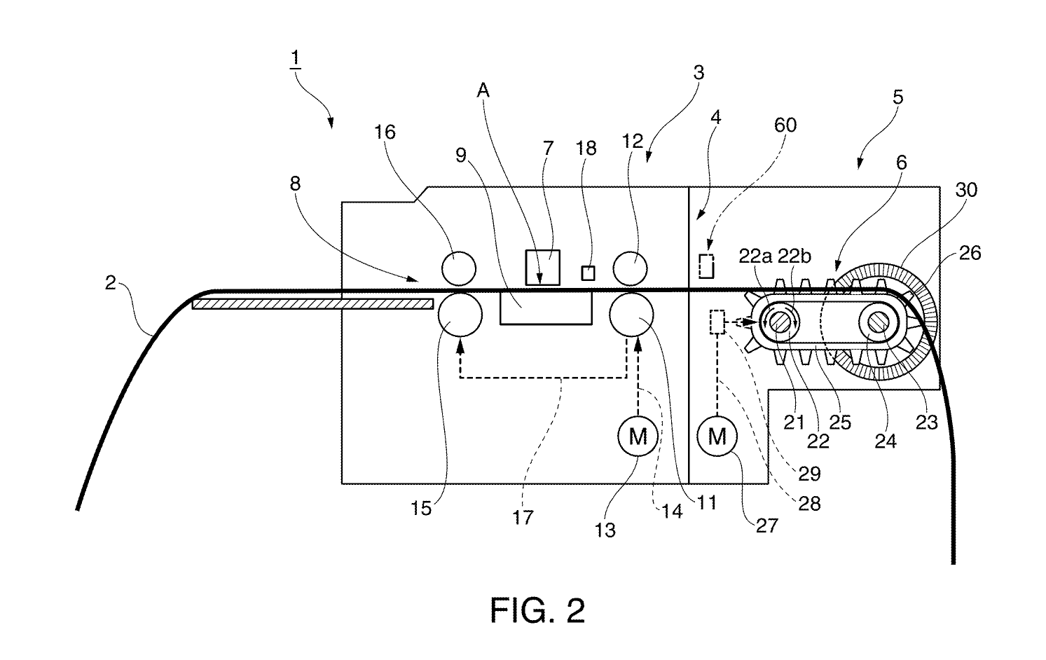

Referring to FIG. 1 and FIG. 2, a printer 1 according to this embodiment of the invention prints on continuous paper 2 that has sprocket holes 2a formed along the longitudinal edges of the paper on opposite sides of the paper width. The printer 1 includes a printer assembly 3, and a tractor unit 5 that is removably installed to a connection unit 4 that is formed at the back side of the printer assembly 3. Continuous paper 2 is delivered into the printer assembly 3 from behind the printer by a tractor 6 contained in the tractor unit 5, and after printing is discharged to the front of the printer from the front of the printer assembly 3.

A paper feed path 8 for conveying the continuous paper 2 passed the printing position A of the printhead 7 is formed inside the printer assembly 3 in a straight line between the front and back of the printer. The printing position A is defined by a platen 9 that is disposed to a position below and opposite the printhead 7 with the paper feed path 8 therebetween.

The printhead 7 is a serial impact dot matrix (SIDM) printhead that prints by causing recording wires to strike an ink ribbon and transfer ink from the ink ribbon to the continuous paper 2, and is opposite the platen 9 with a specific gap therebetween. A printhead that uses a different printing method, such as a thermal head or an inkjet head, or a line printhead of a specific width, can also be used as the printhead 7.

A paper feed roller 11 for conveying the continuous paper 2 passed the printing position A is disposed between the printing position A and the tractor 6. A paper feed pressure roller 12 that presses the continuous paper 2 against the paper feed roller 11 is pushed from above with a specific urging force to the paper feed roller 11. As indicated by the dotted line in FIG. 2, drive power from a paper feed motor 13 is transferred to the paper feed roller 11 through a first drive power transmission mechanism 14 composed of a gear train. The paper feed motor 13 may be a stepper motor, for example, disposed in the printer assembly 3.

A discharge roller 15 for discharging the continuous paper 2 after printing is disposed in front (on the downstream side in the paper feed direction) of the printing position A. A pressure roller 16 for pressing the continuous paper 2 to the discharge roller 15 is pushed from above with a specific urging force to the discharge roller 15. The discharge roller 15 is connected through a second drive power transmission mechanism 17 to the paper feed roller 11, and rotates synchronously with the paper feed roller 11. The paper feed motor 13, first drive power transmission mechanism 14, paper feed roller 11, second drive power transmission mechanism 17, and discharge roller 15 together with the tractor 6 render a continuous paper transportation mechanism.

A paper detector 18 is disposed between the paper feed roller 11 and tractor 6 at a position proximal to the back (the upstream side in the paper feed direction) of the paper feed roller 11. The paper detector 18 is a reflective photosensor, for example, and detects continuous paper 2 conveyed by the tractor 6 through the paper feed path 8.

The tractor 6 includes a drive sprocket 22 mounted on a drive shaft 21 extending widthwise to the printer, a follower sprocket 24 mounted on a follower shaft 23 extending parallel and behind the drive shaft 21, and a tractor belt 25 that is mounted on these sprockets. Tractor pins 26 that can be inserted to the sprocket holes 2a of the continuous paper 2 are formed at a regular interval on the outside surface of the tractor belt 25. Plural drive sprocket 22 and follower sprocket 24 sets are generally disposed with a specific gap therebetween to the drive shaft 21 and follower shaft 23, and a tractor belt 25 is mounted on each set of sprockets 22 and 24.

Drive power from a tractor drive motor 27 is transmitted through a third drive power transmission mechanism 28 to the drive shaft 21. The tractor drive motor 27 is a stepper motor, for example. When the continuous paper 2 is fed forward by the paper feed roller 11, the drive sprocket 22 mounted on the drive shaft 21 is pulled by the continuous paper 2 and rotates in the same direction of rotation 22a as shown in FIG. 2. When torque in the direction causing the drive sprocket 22 to rotate in direction of rotation 22a is transmitted through the third drive power transmission mechanism 28, the drive sprocket 22 is rotationally driven in the same direction of rotation 22a and conveys the continuous paper 2 forward.

For example, the drive sprocket 22 is fixed to rotate in unison with the drive shaft 21, and the drive shaft 21 and third drive power transmission mechanism 28 are connected through a one-way clutch 29. When the one-way clutch 29 is disengaged (off), the drive shaft 21 and third drive power transmission mechanism 28 are directly connected, the drive sprocket 22 can be rotationally driven in direction of rotation 22b, and the continuous paper 2 can be fed in reverse. When backfeeding the continuous paper 2 is not necessary, a mechanism for disengaging the one-way clutch 29 is unnecessary.

So that the drive sprocket 22 can rotate freely on the drive shaft 21 in the direction of rotation 22a in which the continuous paper 2 is conveyed forward, and cannot rotate freely in the opposite direction of rotation 22b, the drive sprocket 22 may be connected through a one-way clutch to the drive shaft 21.

Therefore, as described below, when a first feed distance per unit time of the continuous paper 2 conveyed by the tractor 6 driven synchronously to the paper feed roller 11 is less than a second feed distance per unit time of the continuous paper 2 conveyed by the paper feed roller 11, the tractor 6 rotates following the continuous paper 2 conveyed by the paper feed roller 11.

To detect how much the tractor 6 has turned, a rotary encoder 30 is disposed to the follower sprocket 24 to detect how far the follower sprocket 24 turns. The rotary encoder 30 may alternatively be disposed to the drive sprocket 22.

In order to convey continuous paper 2 by means of the tractor 6 thus configured, the continuous paper 2 is set with the tractor pins 26 inserted to the sprocket holes 2a. When the tractor drive motor 27 is then driven, the drive sprocket 22 causes the tractor belt 25 to turn, the tractor pins 26 sequentially engage the sprocket holes 2a of the continuous paper 2, and the continuous paper 2 can be conveyed forward.

Because the printhead 7 is a serial printhead in this embodiment of the invention, a printing operation that moves the printhead 7 widthwise to the printer, that is, perpendicularly to the transportation direction, and prints one line, and a paper feed operation that advances the continuous paper 2 one line, are alternately executed in order to print on the continuous paper 2. In other words, the continuous paper 2 is intermittently conveyed by the paper feed roller 11 and tractor 6 during printing.

### Control System

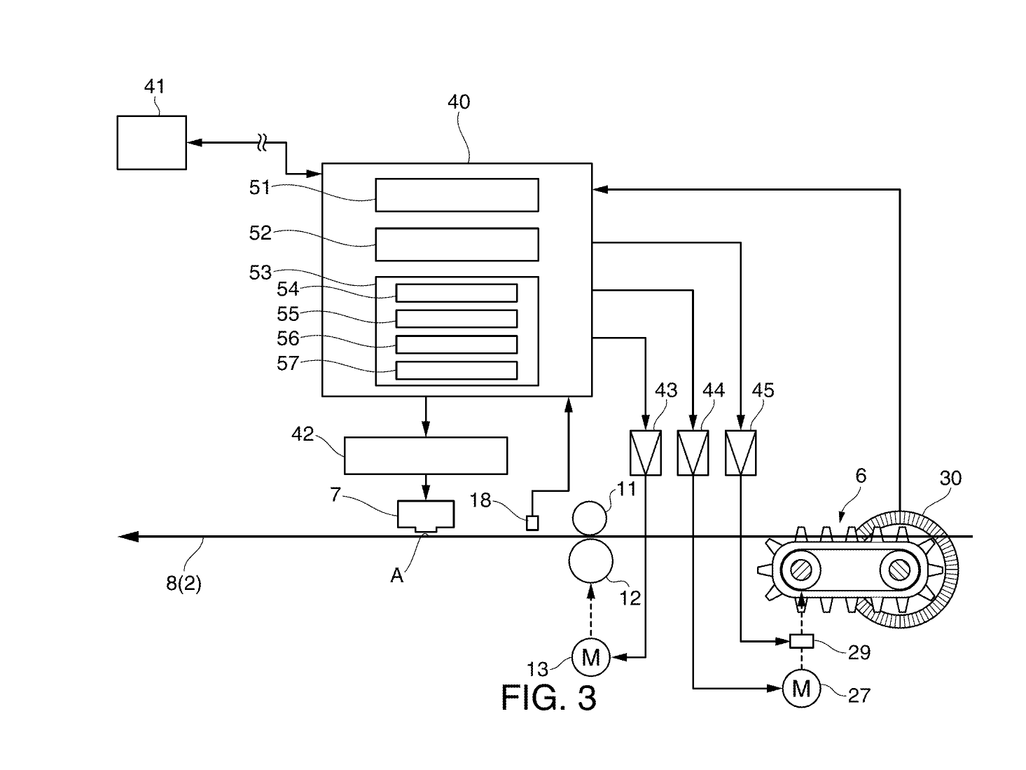

FIG. 3 is a schematic block diagram of the control system of the printer 1. The control system of the printer 1 is built around a control unit 40 including a CPU, ROM, and RAM. Print commands from an external device 41, and detection signals from the paper detector 18 and rotary encoder 30, are input to the control unit 40. The printhead 7 is connected to the output side of the control unit 40 through a head driver 42. In addition, the paper feed motor 13 is connected through a first motor driver 43, the tractor drive motor 27 is connected through a second motor driver 44, and the one-way clutch 29 is connected through a clutch on/off driver 45. The control unit 40 also functions as a tractor drive control unit 51, printing control unit 52, and paper feed roller rotation control unit 53 by executing a control program stored in ROM.

When a print command is received from the external device 41, the tractor drive control unit 51 controls driving the tractor drive motor 27 to rotationally drive the tractor 6, and conveys the continuous paper 2 loaded in the tractor 6. When the leading end of the continuous paper 2 is detected by the paper detector 18, the tractor drive control unit 51 conveys the continuous paper 2 by means of the tractor 6 so that the leading end of the continuous paper 2 is nipped by the paper feed roller 11 and paper feed pressure roller 12, and then passes drive control of the tractor drive motor 27 to the printing control unit 52.

When the continuous paper 2 is held between the paper feed roller 11 and paper feed pressure roller 12, the printing control unit 52 controls driving the paper feed motor 13 and intermittently rotationally drives the paper feed roller 11 at a speed at which the continuous paper 2 can be conveyed the second feed distance per unit time. The paper feed roller 11 is thus intermittently turned a previously defined set amount of rotation.

Parallel to this operation the printing control unit 52 turns the one-way clutch 29 on (operating state), controls driving the tractor drive motor 27 synchronously to continuous paper 2 conveyance by the paper feed roller 11, and intermittently rotationally drives the tractor 6 at a speed enabling conveying the continuous paper 2 the first feed distance, which is less than the second feed distance per unit time.

After the leading end of the continuous paper 2 is set to the printing position A, the printing control unit 52 alternately executes the printing operation that moves the printhead 7 widthwise to the printer perpendicularly to the transportation direction to print, and the transportation operation that conveys the continuous paper 2, and thus prints on the continuous paper 2.

If the second feed distance per unit time of the continuous paper 2 by the paper feed roller 11 is greater than the first feed distance per unit time of the continuous paper 2 by the tractor 6, the paper feed roller 11 and tractor 6 work together to convey the continuous paper 2 when transportation starts by synchronously driving the paper feed roller 11 and tractor 6. Thereafter, the tractor 6 will be pulled the difference between the first and second feed distances and rotate in conjunction with with the continuous paper 2, and the continuous paper 2 will actually be conveyed by the paper feed roller 11.

The paper feed roller rotation control unit 53 functions as a feed distance evaluation unit 54, actual feed distance calculation unit 55, a difference calculation unit 56, and an amount of rotation correction unit 57. The feed distance evaluation unit 54 determines, based on the rotation of the paper feed roller 11, if the feed distance of the continuous paper 2 has reached a predetermined set feed distance. In this embodiment of the invention, this set feed distance is the length of one page of the continuous paper 2.

If the continuous paper 2 feed distance is determined to equal the set feed distance, the actual feed distance calculation unit 55 acquires the amount of rotation of the tractor 6 (the rotation of the follower sprocket 24) based on a detection signal from the rotary encoder 30. The amount of rotation of the tractor 6 includes a driven rotation component resulting from drive control by the printing control unit 52, and a follower rotation component resulting from being pulled by the continuous paper 2 conveyed by the paper feed roller 11. Based on the acquired amount of rotation of the tractor 6, the actual feed distance calculation unit 55 calculates the actual feed distance of the continuous paper 2 by the paper feed roller 11.

When the actual feed distance is calculated by the actual feed distance calculation unit 55, the difference calculation unit 56 calculates the difference between the set feed distance and the actual feed distance. Once this difference is calculated, the amount of rotation correction unit 57 controls rotation of the paper feed roller 11 to eliminate this difference the next time the continuous paper is conveyed, and corrects the feed distance of the continuous paper 2 by the paper feed roller 11. More specifically, when positioning the leading end of the next print page of the continuous paper 2 to the printing position A, a rotation correction amount corresponding to the calculated difference is added to the set feed distance of the paper feed roller 11, and the paper feed roller 11 is turned a rotational distance equal to the sum of the set feed distance and the rotation correction amount.

### Printing Operation

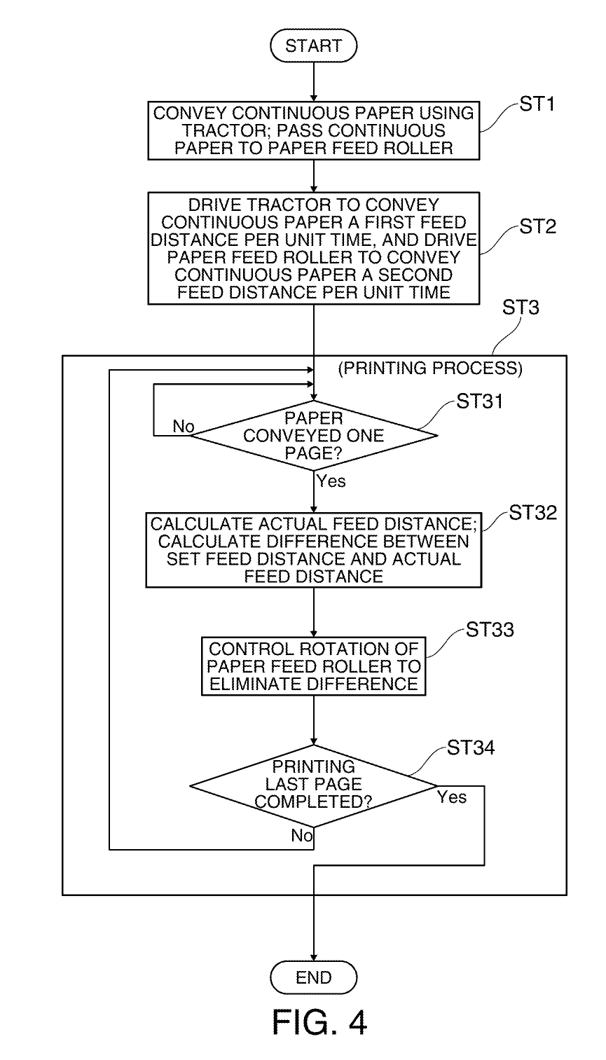

FIG. 4 is a flow chart describing primarily the transportation operation when printing on continuous paper 2.

When the printer 1 receives a print command from the external device 41, the tractor 6 is driven to convey the continuous paper 2 loaded in the tractor 6 to the paper feed path 8. When the paper detector 18 detects the leading end of the continuous paper 2, the tractor 6 conveys the continuous paper 2 a specific feed distance only, and passes the continuous paper 2 to the paper feed roller 11. More specifically, the leading end of the continuous paper 2 is fed to the nipping point of the paper feed pressure roller 12 (step ST1).

The tractor 6 is then intermittently rotationally driven at a speed enabling conveying the continuous paper 2 the first feed distance per unit time, and the paper feed roller 11 is intermittently rotationally drives at a speed enabling conveying the continuous paper 2 the second feed distance per unit time (step ST2). As a result, the continuous paper 2 is conveyed and the printing start position at the leading end of the continuous paper 2 is set to the printing position A.

The printing operation that prints while moving the printhead 7 in a direction perpendicular to the transportation direction, and the transportation operation that conveys the continuous paper 2 a specific distance, then alternately repeat to print on the continuous paper 2 (step ST3).

In step ST3, each time the feed distance of the continuous paper 2 calculated based on rotation of the paper feed roller 11 reaches the set feed distance that conveys the continuous paper 2 the distance of one page (step ST31), the actual feed distance that is based on the rotation of the tractor 6 following the continuous paper 2 is calculated. The difference between the set feed distance and the actual feed distance is then calculated (step ST32).

After this difference is calculated and the continuous paper 2 is fed to the next page, the rotation correction amount for additionally conveying the continuous paper 2 the amount of the calculated difference is added to the set feed distance of the paper feed roller 11, the paper feed roller 11 is driven an amount of rotation equal to the sum of the set feed distance and the rotation correction amount, and the continuous paper 2 is conveyed (step ST33).

Step ST32 and step ST33 execute repeatedly each time the continuous paper 2 is conveyed one page until the print job specified by the print command is completed (step ST34).

### Conveying Continuous Paper When Not Printing

When the continuous paper 2 is conveyed in the printer 1 according to this embodiment of the invention at times other than during printing, the tractor 6 is rotationally driven synchronously to the paper feed roller 11 at a speed that enables conveying the continuous paper 2 the same feed distance as the paper feed roller 11.

More specifically, there is no need to consider a drop in print quality due to variation in the feed distance of the continuous paper 2 by the tractor 6 when the continuous paper 2 is conveyed forward when not printing. In addition, if the tractor 6 is left completely in the follower mode, a heavy load is applied from the tractor 6 side to the continuous paper 2 conveyed by the paper feed roller 11, and the continuous paper 2 may tear. This embodiment of the invention therefore rotationally drives the tractor 6 synchronously to the paper feed roller 11 at a speed that can convey the continuous paper 2 the same feed distance as the paper feed roller 11.

If slack develops in the continuous paper 2 between the tractor 6 and paper feed roller 11 when backfeeding the continuous paper 2, the continuous paper 2 will interfere with surrounding parts, possibly leading to a paper jam or the continuous paper 2 tearing. When backfeeding the continuous paper 2, this embodiment of the invention therefore also rotationally drives the tractor 6 synchronously to the paper feed roller 11 at a speed that can convey the continuous paper 2 the same feed distance as the paper feed roller 11. Note that in this case the one-way clutch 29 is turned off (disengaged) so that the drive shaft 21 and third drive power transmission mechanism 28 are directly connected and torque for backfeeding the continuous paper 2 can be transmitted.

### Operational Effect of the Embodiment

When printing on the continuous paper 2, this embodiment of the invention drives both the paper feed roller 11 and tractor 6 to convey the continuous paper 2. As a result, the load on the continuous paper 2 when paper feeding starts can be reduced compared with a configuration in which the tractor 6 only follows the continuous paper 2. Therefore even when perforations are formed at a regular interval lengthwise to the continuous paper 2, separation of the continuous paper 2 at a perforation when paper feeding starts can be avoided.

Furthermore, because the tractor 6 can rotate freely and follow the continuous paper 2 conveyed by the paper feed roller 11, and the second feed distance of the continuous paper 2 per unit time by the paper feed roller 11 is greater than the first feed distance by means of the tractor 6, actual transportation of the continuous paper 2 during printing can be handled by the paper feed roller 11. As a result, because the continuous paper 2 is thus conveyed by the continuous paper 2 by means of the coefficient of friction between the paper feed roller 11 and continuous paper 2, variation in the feed distance of the continuous paper 2 can be suppressed even if the tractor 6 is driven.

In addition, if the feed distance of the continuous paper 2 calculated from the rotation of the paper feed roller 11 reaches a predetermined set feed distance, rotation of the paper feed roller 11 is controlled to compensate for this feed distance deficiency. More specifically, the actual feed distance of the continuous paper 2 by the paper feed roller 11 is calculated based on the rotation of the tractor 6, and the feed distance deficiency caused by slipping between the paper feed roller 11 and continuous paper 2 is calculated as the difference between the set feed distance and the actual feed distance. The continuous paper 2 can therefore be conveyed with good precision.

The tractor drive motor 27 is a different motor than the paper feed motor 13 that drives the paper feed roller 11, and is disposed to the tractor unit 5. As a result, because the first drive power transmission mechanism 14 [114, sic] that transfers drive power from the paper feed motor 13 to the paper feed roller 11, and the third drive power transmission mechanism 28 that transfers drive power from the tractor drive motor 27 to the tractor 6, can be configured separately, the configuration of each of the drive power transmission mechanisms can be simple, and noise can be suppressed.

Furthermore, because the transmission path that transfers drive power from the tractor drive motor 27 to the tractor 6 can be rendered in the tractor unit 5, a configuration that enables removing the tractor unit 5 from the printer assembly 3 can be easily used.

### Other Embodiments

A paper feed distance that conveys the continuous paper 2 the length of one page is set as the set feed distance in the foregoing embodiment, but the set feed distance may be the feed distance of the continuous paper 2 when the paper feed roller 11 is turned only the set amount of rotation used to intermittently rotate the paper feed roller 11. In this configuration the difference between the set feed distance and the actual feed distance is calculated each time the paper is conveyed intermittently, and the deficient feed distance of the continuous paper 2 can be corrected the next time the continuous paper 2 is fed intermittently. The continuous paper 2 can therefore be conveyed even more precisely.

The embodiment described above also calculates the actual feed distance of the continuous paper 2 by the paper feed roller 11 based on the amount of tractor 6 rotation detected by a rotary encoder 30 disposed to the tractor 6. Alternatively, a configuration that has a sensor disposed to the printer assembly 3 or the tractor unit 5 for detecting how far the sprocket holes 2a of the continuous paper 2 have moved, and calculates the actual feed distance of the continuous paper 2 by the paper feed roller 11 based on how far the sprocket holes 2a moved, is also conceivable.

For example, as shown by the imaginary line in FIG. 2, a sensor 60 such as a transmissive photosensor could be disposed to an end part of the width of the paper feed path 8 inside the tractor unit 5, the number of sprocket holes 2a that pass the detection position of the sensor 60 counted, and the actual feed distance of the continuous paper 2 calculated based on the resulting count.

Furthermore, because the feed distance deficiency of the continuous paper 2 by the paper feed roller 11 can be previously measured and determined, the rotation correction amount of the paper feed roller 11 required to eliminate this deficiency can also be determined in advance. The continuous paper 2 can therefore be conveyed with good precision even if the paper feed roller 11 is rotated using the rotation correction amount added by the amount of rotation correction unit 57 (see FIG. 3) when the feed distance calculated based on rotation of the paper feed roller 11 reaches the set feed distance. Because this configuration does not need a sensor to calculate the actual feed distance, the manufacturing cost of the printer 1 can be suppressed.

As described above, the embodiment described above intermittently conveys the continuous paper 2 by means of the paper feed roller 11 and tractor 6 when printing on the continuous paper 2. The invention can also be applied when the tractor 6 is driven at a constant speed. The invention can also be applied when the paper feed roller 11 and tractor 6 are driven at a constant speed.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. A continuous paper transportation control method using a tractor that conveys the continuous paper while sequentially engaging engaging units with engagement holes formed in the continuous paper along the length of the continuous paper, and a paper feed roller that conveys the continuous paper received from the tractor through a paper transportation path passed a printing position, comprising as steps that are executed at least when printing on the continuous paper steps of:
setting the tractor to a state enabling rotation following the continuous paper that is pulled in the direction of the paper feed roller by the paper feed roller;
rotationally driving the tractor at a speed enabling conveying the continuous paper at a first feed distance per unit time and conveying the continuous paper; and
rotationally driving the paper feed roller at a speed enabling conveying the continuous paper a second feed distance that is greater than the first feed distance per unit time.

2. The continuous paper transportation control method described in claim 1, further comprising a step of:
rotating the paper feed roller an additional specific amount when the feed distance of the continuous paper calculated based on the amount of rotation of the paper feed roller reaches a predetermined set feed distance.

3. The continuous paper transportation control method described in claim 2, further comprising steps of:
calculating an actual feed distance of the continuous paper based on an amount of rotation of the tractor or an amount of movement of the engagement holes; and
if the continuous paper feed distance calculated based on the amount of rotation of the paper feed roller reaches the set feed distance, additionally driving the paper feed roller so that the actual feed distance matches the set feed distance.

4. The continuous paper transportation control method described in claim 2, wherein:
the set feed distance is a feed distance equal to a predetermined length of one printed page of the continuous paper.

5. The continuous paper transportation control method described in claim 2, further comprising steps of:
intermittently rotationally driving the paper feed roller and conveying the continuous paper a predetermined set amount of rotation in the length direction of the continuous paper;
intermittently rotationally driving the tractor and conveying the continuous paper synchronously to intermittently rotationally driving the paper feed roller,
the set feed distance being the feed distance of the continuous paper when the paper feed roller is rotated the set amount of rotation.

6. The continuous paper transportation control method described in claim 1, wherein:
during continuous paper transportation when not printing,
the tractor is rotationally driven synchronously to the paper feed roller at a speed enabling conveying the continuous paper the same feed distance as the paper feed roller.

7. The continuous paper transportation control method described in claim 1, wherein:
a stepper motor is used to rotationally drive the tractor.

8. A printer, comprising:
a printhead;
a transportation path for continuous paper that passes a printing position of the printhead;
a tractor for conveying the continuous paper through the transportation path while sequentially engaging engaging units with engagement holes formed in the continuous paper along the length of the continuous paper;
a paper feed roller disposed between the printing position and the tractor for conveying the continuous paper through the transportation path; and
a control unit that controls a transportation operation to rotationally drive the paper feed roller and the tractor to convey the continuous paper, and a printing operation that prints on the continuous paper by means of the printhead;
wherein, at least when printing on the continuous paper, the tractor is in a state enabling rotation following the continuous paper that is pulled in the direction of the paper feed roller by the paper feed roller; and
when printing on the continuous paper, the control unit drives the tractor at a speed enabling conveying the continuous paper at a first feed distance per unit time, and drives the paper feed roller at a speed enabling conveying the continuous paper a second feed distance that is greater than the first feed distance per unit time.

9. The printer described in claim 8, wherein:
the control unit rotates the paper feed roller an additional specific amount when the calculated feed distance of the continuous paper that is calculated based on the amount of rotation of the paper feed roller reaches a predetermined set feed distance.

10. The printer described in claim 9, further comprising:
an encoder that detects an amount of rotation of the tractor, or a sensor that detects an amount of movement of the engagement holes in the continuous paper;
the control unit including a feed distance evaluation unit that determines if the calculated feed distance reached the set feed distance,
an actual feed distance calculation unit that calculates the actual feed distance of the continuous paper based on output from the encoder or output from the sensor,
a difference calculation unit that calculates the difference between the actual feed distance and the set feed distance, and
an amount of rotation correction unit that controls the amount of rotation of the paper feed roller in the direction eliminating the difference.

11. The printer described in claim 9, wherein:
the set feed distance is a feed distance equal to a predetermined length of one printed page of the continuous paper.

12. The printer described in claim 9, wherein:
the control unit intermittently rotationally drives the paper feed roller a predetermined set amount of rotation in the length direction of the continuous paper, intermittently rotationally drives the tractor synchronously to intermittently rotationally driving the paper feed roller, and conveys the continuous paper,
the set feed distance being the feed distance of the continuous paper when the paper feed roller is rotated the set amount of rotation.

13. The printer described in claim 8, wherein:
during continuous paper transportation when not printing, the control unit rotationally drives the tractor synchronously to the paper feed roller at a speed enabling conveying the continuous paper the same feed distance as the feed distance of the paper feed roller.

14. The printer described in claim 8, further comprising:
a tractor drive motor that rotationally drives the tractor;
a drive power transmission mechanism that transfers output rotation of the tractor drive motor to the tractor as rotational drive power for the tractor; and
a clutch mechanism that connects the tractor to the drive power transmission mechanism so that the tractor can rotate following the continuous paper.

15. The printer described in claim 14, further comprising:
a printer assembly including the printhead and the paper feed roller; and
a tractor unit including the tractor, the tractor drive motor, the drive power transmission mechanism, and the clutch mechanism,
the tractor unit being removably installed to the printer assembly.

16. The printer described in claim 15, wherein:
the tractor drive motor is a stepper motor.
